(19) United States
(12) Patent Application Publication
(10) Pub. No.: US 2009/0180082 A1
(43) Pub. Date: Jul. 16, 2009

(54) Arrays of LEDS/Laser Diodes for Large Screen Projection Displays

(76) Inventor: William S. Oakley, San Jose, CA (US)

Correspondence Address: TIPS GROUP;c/o Intellevate LLC, P. O. BOX 52050, Minneapolis, MN, 55402, US

(21) Appl. No.: 12/015,506

(22) Filed: Jan. 16, 2008

(51) Int. Cl. G03B 21/26

(52) U.S. Cl. 353/94

(57) ABSTRACT

In one embodiment, a system is provided. The system includes an array of a first plurality of narrowband light sources. The system also includes a first beam collecting component arranged to receive light from the first plurality of narrowband light sources and arranged to output light including light from each light source of the first plurality of narrowband light sources. In one embodiment, the light sources are laser diodes. In another embodiment, the light sources are light emitting diodes (LEDs).

### BACKGROUND

Projection of motion pictures in theatres is still primarily done based on film and projection technology little changed since the dawn of motion pictures. However, compared to film, digital media allows for much easier storage of representations of an image. In order to move beyond film-based projection, it would be useful to provide a digital projector which fits general theater requirements.

Furthermore, a consortium of studios has set forth a standard for future digital projection systems. While this standard is by no means final, it provides a rough guide as to what a system must do—what specifications must be met. Thus, it may be useful to provide a digital projection system which meets the standards of the studio consortium.

### BRIEF DESCRIPTION OF THE DRAWINGS

The present invention is illustrated by way of example in the accompanying drawings. The drawings should be understood as illustrative rather than limiting.

FIG. 1 illustrates an embodiment of an array of light sources which may be used with a projector.

FIG. 2 illustrates another embodiment of an array of light sources which may be used with a projector.

FIG. 3 illustrates an embodiment of an array of light sources fabricated on a substrate.

FIG. 4 illustrates another embodiment of an array of light sources fabricated on a substrate.

FIG. 5 illustrates an embodiment of a process of installing an array of light sources.

FIG. 6 illustrates an embodiment of a process of operating an array of light sources.

FIG. 7 illustrates an embodiment of a system using a computer and a projector.

FIG. 8 illustrates an embodiment of a computer which may be used with the system of FIG. 7, for example.

FIG. 9 illustrates an embodiment of a projector which may be used with the various embodiments described herein.

### DETAILED DESCRIPTION

A system, method and apparatus is provided for an array of LEDs or LDs (laser diodes) as light sources. The specific embodiments described in this document represent exemplary instances of the present invention, and are illustrative in nature rather than restrictive.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments.

The projectors used to illuminate large screens with image generated by dynamic image chips such as LCoS devices typically use broad band optical sources that generate substantial optical energy outside the visible band of interest. Smaller display screens can use Laser Diodes (LD's) or Light Emitting Diodes (LED's) as sources that only emit light in the spectral region of interest. A major limitation of present LD/LED devices is limited brightness. One means to ameliorate this limitation is to use multiple devices and combine outputs optically. Typically this is achieved by dichroic mirrors, but this quickly becomes mechanically complex if more than e few sources are utilized.

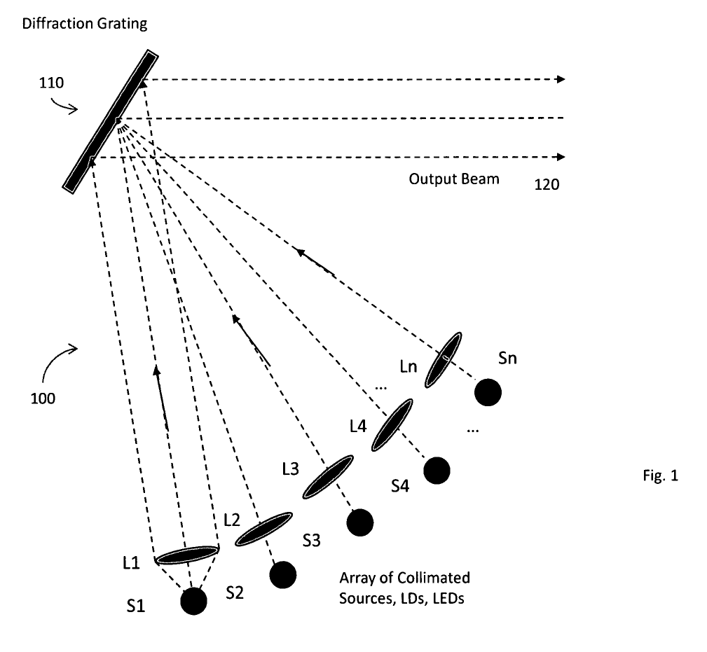

The spectral band output by LEDs is typically about 30 nm wide and that from LDs is even smaller, perhaps only 5 nm wide. A number of these narrow spectral outputs with different wavelengths can be combined by reflecting each from the same region of a diffraction grating but with each input to the grating at a different angle so that the multiple outputs are collinear. It is potentially useful that the output of each individual source first be collimated by use of a small lens close to the LD/LED as in FIG. 1. The figure shows the sources arranged in a small circular arc with their individual collimating lenses centered on their respective output beams so that the collimated outputs illuminate the same area on the diffraction grating and combine to form a single output beam covering a wide spectral gamut, although an RGB array with only three sources is likewise feasible. Also, note that the arc arrangement is not necessarily required for operation—it is useful for illustration purposes in particular.

Referring in more detail to FIG. 1, an array of sources is shown, along with focusing optics and a diffraction grating. System 100 provides and output beam 120 resulting from sources S1-Sn providing light to diffraction grating 110 through focusing optics L1-Ln. Sources S1-Sn can be laser diodes or LEDs of selected wavelengths. Thus, a spectral distribution of light can be provided which varies depending on which sources are turned on or pulsed.

As illustrated, sources S1-Sn are arranged in an arc, with focusing optics L1-Ln (here represented as lenses) arranged in a corresponding arc. However, other arrangements resulting in a similar pattern of beams to diffraction grating 110 can provide similar results. Moreover, diffraction grating 110 can be replaced by a curved diffraction grating in some instances (with potentially different light output geometry).

The visible spectrum covers the range of wavelengths between nominally 400 nm and 700 nm, allowing for up to ten LEDs of different wavelengths, each with about a 30 nm wide output, to be combined by the grating. For laser diodes with a 5 nm or less spectral width the technique will, in principle, allow as many as sixty LD outputs of different wavelengths to be combined over the spectral region. The technique readily allows extension of the spectral region into the near infra-red if desired for simulation or security reasons.

The output wavelength of laser diodes and light emitting diodes changes with temperature so the block of sources shown in FIG. 1 may be mounted in a single block of conductive material, e.g. copper, which is maintained at the same temperature by several thermo-electric coolers (TECs). These devices transfer heat from one side of the device to the other, and the hot side of the devices are cooled by an ambient air flow or by liquid coolant if desired. Temperature control of the sources will enable pulsing at higher output levels and various pulse rates and duration without significant output wavelength drift.

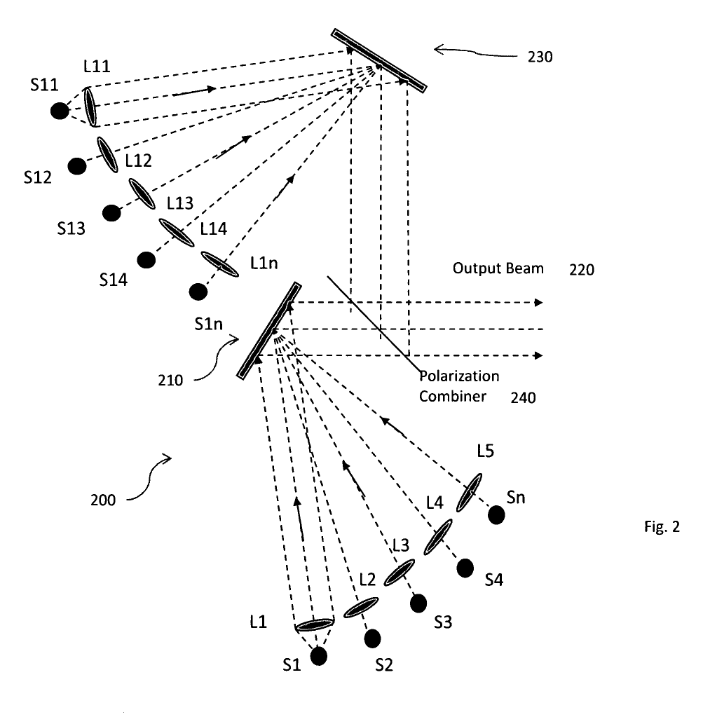

The outputs of LEDs are not polarized but LD outputs are plane polarized. This enables two oppositely polarized beams to be combined by means of a broadband polarizing beam splitter placed in the output beam from diffractive beam combining systems as in FIG. 2. The two diffraction combiners may be out of plane, i.e. the arc of one at right angles to the arc of the other.

Turning to FIG. 2 in more detail, a system 200 is provided with two sets of sources (S1-Sn and S11-S1n), and corresponding optical elements. Sources S1-Sn are focused through focusing optics L1-Ln to provide light to diffraction grating 210, leading to a beam of light to polarization combiner 240. Sources S11-S1n are likewise focused through focusing optics L11-L1n to provide light to diffraction grating 230, similarly leading to a beam of light to polarization combiner 240. Polarization combiner 240 then combines the two beams of light to produce output beam 220. In some embodiments, this results in an output beam with two orthogonal polarization components (which can then be separated again). Alternatively, one may pulse the two sets of sources (S1-Sn and S11-S1n) in an alternating sequence, resulting in time-varying polarization.

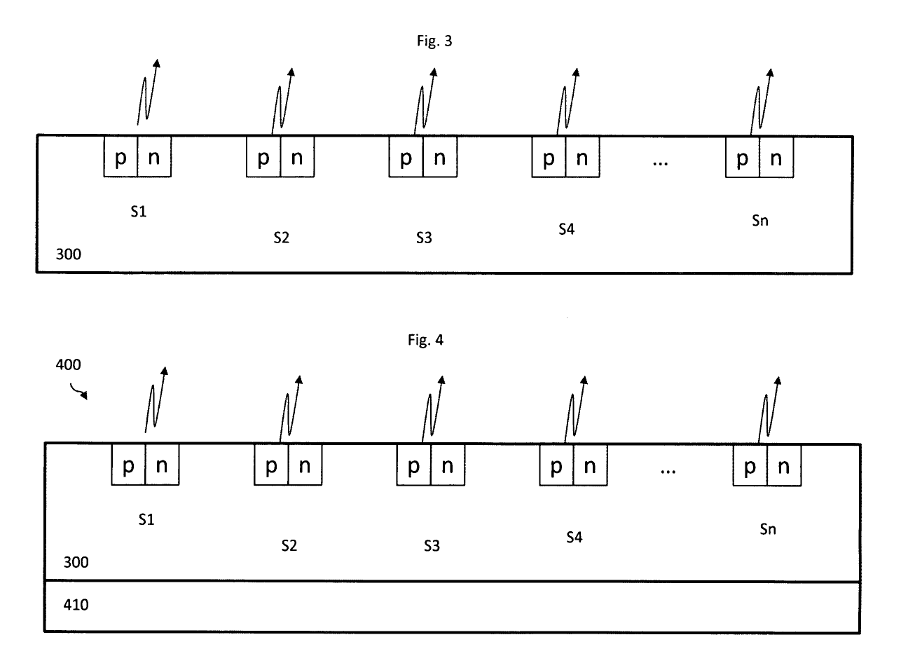

As mentioned previously, the arc geometry of sources may not be needed. It may also not be practical. FIG. 3 illustrates an embodiment of an array of sources on a substrate. Substrate 300 has fabricated thereon (or within) sources S1, S2, S3, S4 and Sn (each represented by pn junctions in a semiconductor substrate, for example). With appropriate optics arranged above, these sources can be focused on to a common optical element, such as a diffraction grating, leading to a similar arrangement to that shown in FIG. 1, for example. FIG. 4, in turn, provides apparatus 400, which includes the substrate 300 of FIG. 3, and an additional cooling layer 410. Cooling layer 410 may include a simple high conductivity backing (e.g. copper), or may include a more sophisticated cooling apparatus, such as a heat sink or thermal electric cooler, for example. Cooling layer 410 may be expected to maintain substrate 300 at a common and desired temperature, assuming normal operation of the cooling layer 410. Note that in some embodiments, substrates 300 and 400 will provide a surface for LEDs or diodes originally fabricated on other substrates. In such embodiments, substrates 300 and 400 provide a common cooling platform, which then allows for a relatively uniform wavelength of light generated over time.

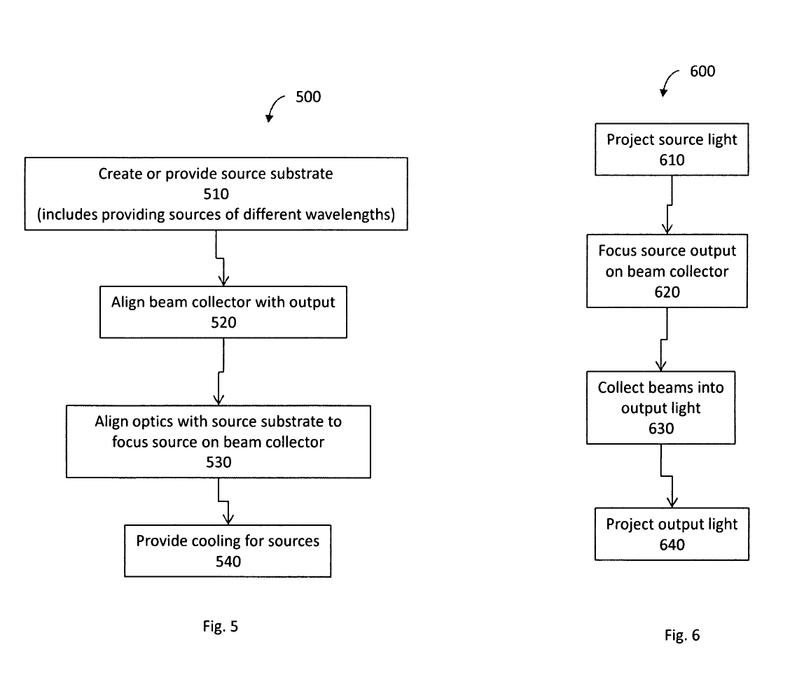

Process 500 of FIG. 5 provides further illustration of creation of an array of sources. Process 500 includes providing the light sources (e.g. fabricating a wafer with light sources), aligning a desired output with a beam collector, aligning optics and the source substrate with the beam collector, and providing cooling for the sources. Process 500 and other processes of this document are implemented as a set of modules, which may be process modules or operations, software modules with associated functions or effects, hardware modules designed to fulfill the process operations, or some combination of the various types of modules, for example. The modules of process 500 and other processes described herein may be rearranged, such as in a parallel or serial fashion, and may be reordered, combined, or subdivided in various embodiments.

Process 500 initiates with creation or provision of light sources, such as an array of LEDs or laser diodes at module 510. At module 520, a beam collector (a component such as a diffraction grating) is aligned with a desired output. At module 530, a source substrate or other set of light sources is aligned with optical elements and the beam collector such that the light sources provide light to the desired output. At module 540, cooling is provided for the light sources, such as through use of a thermo-electric cooler, for example. Through this process, one may provide a light source with a variety of sources.

To further increase brightness each source S in FIGS. 1 and 2 can be an array of LEDs or laser diodes. Each source can also be the output end of a closely packed bundle of fiber optic pigtails, the other end of each fiber in a bundle being attached to a laser diode of like output wavelength. In this manner the outputs of many laser diodes can be combined, although the spatial separation of the fiber outputs increases the effective spread of the output beam.

Each source in FIGS. 1 and 2 can be a small closely packed two dimensional (2D) array of LEDs or laser diodes of like wavelength. The optical system is configured so each source is located in a pupil of the optical system that illuminated the image generating chip, the size of each source 2D array being determined by the acceptance field angle of the final projection lens, referenced back to the source array location. For a typical projection lens with an input format of 12×24 mm, for example, a number of LEDs/LDs combined to form a source in the array depends on the physical size of the semiconductor chip, LED or LD, in the array. For example with a 2×2 mm chip (die) size the array can contain as many as 6×12 dies or 72 individual diode sources.

To gather the output of this many diodes into a single beam a similarly sized array of lenses with the same center to center spacing as the dies is placed just in front of the laser source array to collimate the individual beams. The output for an LED is typically a wide cone, and a spherical lens is used for collimation; a laser diode typically has an output beam that is 5×30 degrees and requires a cylindrical lens to collimate the beam. The output of the diode array is thus collimated and reflected from the diffraction grating coaxial with other similar beams to illuminate an LCoS image generating chip.

One useful configuration is to use a remote pupil imaging system that images the diode array into the pupil of a lens used to relay the image of the LCoS chip to the input plane of a projection lens. If a 3D display is required utilizing a diode array source then two polarizations are required that can be pulsed sequentially. The outputs from two similar diode arrays can be combined through a polarization element, or each alternate diode in the array can be rotated in a checker-board pattern to provide both planes of polarization, so the output polarization is selectable on a pulse by pulse basis.

The arrays of closely packed optical diodes will generate significant heat load in a small area, for example with an array of 72 diodes with each diode consuming 1 Watt of input power, the 6×12 diode array will generate 72 watts in 2.88 square centimeters, a heat load of 25 watts per square centimeter. This will require active cooling of the common heat sink on which each diode array is mounted. The active cooling can be achieved by Thermo-electric coolers or by a closed or open cycle liquid cooler.

The estimated optical power to achieve full brightness on a large screen is in the order of 30-100 watts, and with laser diodes at perhaps 20% efficiency this implies 150-500 watts of input power, or 150 to perhaps 750 separate sources. The lower end of this range is at least marginally feasible with existing diodes and the approach will become increasingly viable as optical diodes of greater output power and efficiency become available.

A process of operating the light source may also be useful. FIG. 6 illustrates an embodiment of a process 600 for operating a light source. Process 600 includes illuminating light sources, focusing source output on a beam collector, collecting beams to form an output light beam, and projecting the output light.

Process 600 initiates with projection or illumination of light sources at module 610. At module 620, the light source output is focused on a beam collector, such as a diffraction grating or a parabolic optical element. At module 630, the various focused beams are collected to provide an output beam. At module 640, the output beam is then projected, such as into a projection system.

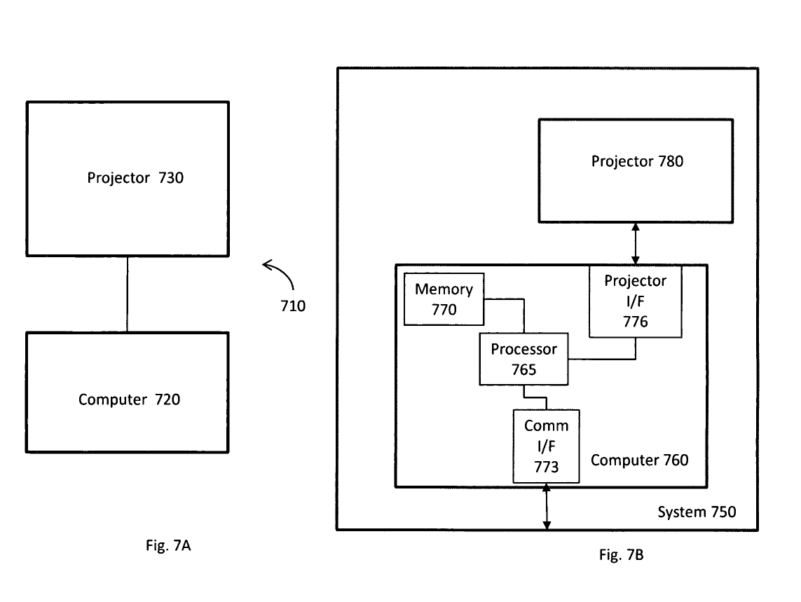

The overall system used with various implementations (of the methods and apparatuses described above) may also be instructive. FIG. 7A illustrates an embodiment of a system using a computer and a projector. System 710 includes a conventional computer 720 coupled to a digital projector 730. Thus, computer 720 can control projector 730, providing essentially instantaneous image data from memory in computer 720 to projector 730. Projector 730 can use the provided image data to determine which pixels of included LCoS display chips are used to project an image. Additionally, computer 720 may monitor conditions of projector 730, and may initiate active control to shut down an overheating component or to initiate startup commands for projector 730.

FIG. 7B illustrates another embodiment of a system using a computer and projector. System 750 includes computer subsystem 760 and optical subsystem 780 as an integrated system. Computer 760 is essentially a conventional computer with a processor 765, memory 770, an external communications interface 773 and a projector communications interface 776.

The external communications interface 773 may use a proprietary (a standard developed for such a device but not publicized by its developer), or a publicly available communications standard, and may be used to receive both digital image data and commands from a user. The projector communications interface 776 provides for communication with projector subsystem 780, allowing for control of LCoS chips (not shown) included in projector subsystem 780, for example. Thus, projector communications interface 776 may be implemented with cables coupled to LCoS chips, or with other communications technology (e.g. wires or traces on a printed circuit board) coupled to included LCoS chips. Other components of computer subsystem 760, such as dedicated user input and output modules, may be included, depending on the needs for functionality of a conventional computer system in system 750. System 750 may be used as an integrated, standalone system—thus allowing for the possibility that each theater may use its own projector with a built-in control system, for example.

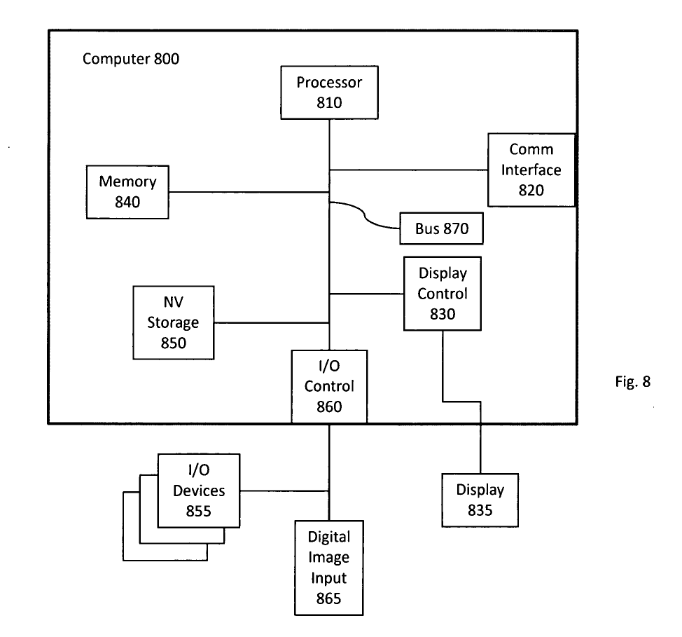

FIG. 8 illustrates an embodiment of a computer which may be used with systems of FIG. 7, for example. The following description of FIG. 8 is intended to provide an overview of computer hardware and other operating components suitable for performing the methods of the invention described above and hereafter, but is not intended to limit the applicable environments. Similarly, the computer hardware and other operating components may be suitable as part of the apparatuses and systems of the invention described above. The invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 8 shows one example of a conventional computer system that can be used as a client computer system or a server computer system or as a web server system. The computer system 800 interfaces to external systems through the modem or network interface 820. It will be appreciated that the modem or network interface 820 can be considered to be part of the computer system 800. This interface 820 can be an analog modem, isdn modem, cable modem, token ring interface, satellite transmission interface (e.g. “direct PC”), or other interfaces for coupling a computer system to other computer systems. In the case of a closed network, a hardwired physical network may be preferred for added security.

The computer system 800 includes a processor 810, which can be a conventional microprocessor such as microprocessors available from Intel or Motorola. Memory 840 is coupled to the processor 810 by a bus 870. Memory 840 can be dynamic random access memory (dram) and can also include static ram (sram). The bus 870 couples the processor 810 to the memory 840, also to non-volatile storage 850, to display controller 830, and to the input/output (I/O) controller 860.

The display controller 830 controls in the conventional manner a display on a display device 835 which can be a cathode ray tube (CRT) or liquid crystal display (LCD). Display controller 830 can, in some embodiments, also control a projector such as those illustrated in FIGS. 1 and 5, for example. The input/output devices 855 can include a keyboard, disk drives, printers, a scanner, and other input and output devices, including a mouse or other pointing device. The input/output devices may also include a projector such as those in FIGS. 1 and 5, which may be addressed as an output device, rather than as a display. The display controller 830 and the I/O controller 860 can be implemented with conventional well known technology. A digital image input device 865 can be a digital camera which is coupled to an I/O controller 860 in order to allow images from the digital camera to be input into the computer system 800. Digital image data may be provided from other sources, such as portable media (e.g. FLASH drives or DVD media).

The non-volatile storage 850 is often a magnetic hard disk, an optical disk, or another form of storage for large amounts of data. Some of this data is often written, by a direct memory access process, into memory 840 during execution of software in the computer system 800. One of skill in the art will immediately recognize that the terms “machine-readable medium” or “computer-readable medium” includes any type of storage device that is accessible by the processor 810 and also encompasses a carrier wave that encodes a data signal.

The computer system 800 is one example of many possible computer systems which have different architectures. For example, personal computers based on an Intel microprocessor often have multiple buses, one of which can be an input/output (I/O) bus for the peripherals and one that directly connects the processor 810 and the memory 840 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 840 for execution by the processor 810. A Web TV system, which is known in the art, is also considered to be a computer system according to the present invention, but it may lack some of the features shown in FIG. 8, such as certain input or output devices. A typical computer system will usually include at least a processor, memory, and a bus coupling the memory to the processor.

In addition, the computer system 800 is controlled by operating system software which includes a file management system, such as a disk operating system, which is part of the operating system software. One example of an operating system software with its associated file management system software is the family of operating systems known as Windows(r) from Microsoft Corporation of Redmond, Wash., and their associated file management systems. Another example of an operating system software with its associated file management system software is the Linux operating system and its associated file management system. The file management system is typically stored in the non-volatile storage 850 and causes the processor 810 to execute the various acts required by the operating system to input and output data and to store data in memory, including storing files on the non-volatile storage 850.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-roms, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

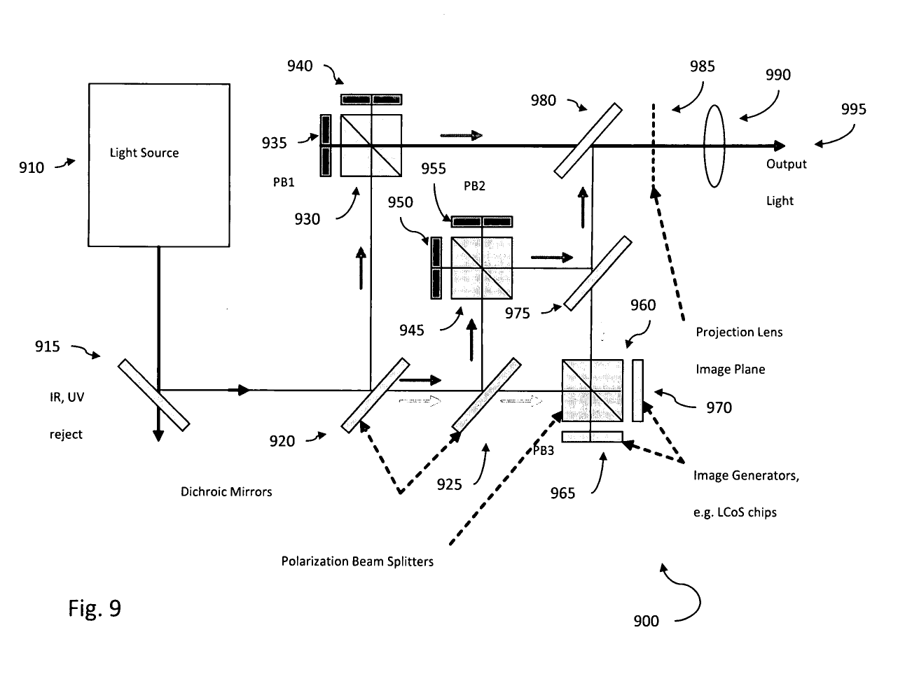

Various projectors may be used with such a filter system. A high efficiency optical design for three color RGB (red, green, blue) image projectors is shown in FIG. 9 that uses six LCoS image planes to obtain both optical polarizations in all colors and is suitable for slide or dynamic video presentations to large screens. A light source (910) is stripped of IR and UV components by an IR/UV rejection filter (915) to provide input to a first dichroic mirror (DM1-920) which reflects the blue portion of the spectrum to a polarizing beam splitter (PB1-930). The remainder of the spectrum passes through the dichroic mirror (920) to a second dichroic mirror (DM2-925), which reflects the red portion of the spectrum to a second polarizing beam splitter (PB2-945). The remaining spectrum passes to a third polarizing beam splitter (PB3-960).

Each of the three beam splitters separates its portion of the spectrum into two orthogonal polarization components, each of which is directed to an active LCoS (Liquid Crystal on Silicon) image generation plane (chips 935, 940, 950, 955, 965 and 970). Both polarization components are selectively polarization rotated on a pixel by pixel basis by an electrical signal applied to the LCoS display chips, so as to modulate the input light and impart an image onto the throughput light. Polarization modulated light is reflected from each LCoS chip back through the polarizing beam splitters (930, 945 and 960), so that both polarizations exit from the polarizing beam splitter and are re-combined with similarly processed light of the other spectral portions via dichroic mirrors (975 and 980) to form a white image (at projection lens image plane 985) which is focused on a remote screen using a projection lens (990) to provide output light 995.

Application of a voltage to an LCoS chip pixel that is insufficient for 90 degree rotation of the optical polarization results in a smaller rotation of the plane of polarization for a beam reflected from an LCoS chip. On passing back (of the beam) through the polarizing beam splitter the rotated beam is split into two orthogonal polarized components of different intensities that exit the beam splitter in different directions. Thus the intensity of the output beam is reduced in proportion to the degree of polarization rotation (i.e. voltage on the pixel), and the unrotated portion is returned along its entrance path back toward the source.

Although many optical projection systems have been designed, multicolor displays using reflective LCoS image generation chips, one design the inventor is aware of is not well suited to large high brightness displays. The LCoS image generation devices employ a liquid crystal layer sandwiched between a transparent optical surface and a silicon electronic chip which applies a voltage to the liquid crystal layer on a pixel by pixel basis, causing spatially localized polarization rotation of light and thereby enabling an image to be imparted to light input through the transparent surface and reflecting back from the chip surface. The LCoS devices are universally employed in a reflective mode where the reflected light contains the image information.

The above referenced design uses four beam splitting cubes and several color absorption filters. It suffers from a low light efficiency as the input light is first split into two polarizations, each of which is then passed through color filters. This implementation causes half of the polarized light to be absorbed in the color filters. The absorbed light significantly heats the filters, trapping the heat between the polarizing cubes. Consequently this design, although compact, is only compatible with low intensity light, perhaps small fractions of a watt. A large screen multi-media display must be capable of transmitting several hundred watts of light, with potentially tens of watts absorbed in the image generating chips.

In contrast the proposed optical design implementation first separates the input light on a spectral basis, blue, red, then green light, using color separating dichroic mirrors, and each color is then input to its own polarizing beam splitter which directs polarized light to two LCoS image planes, one for each light polarization state. The light is thus spread over six separate LCoS chips. The reflected output images from the three beam splitters each contain both optical polarizations for their respective color, and the colored images are then re-combined using dichroic mirrors. By this means no light is absorbed in color filters and the system is capable of much higher optical power throughput as the dichroic mirrors absorb comparatively little light, and each color path is very efficient with minimal light loss at the LCoS planes. The LCoS image chips are accessible from the rear (the non-image side) and active chip cooling may therefore be employed to maintain each chip within a preferable operating temperature range.

In one embodiment, the blue light is first separated using a blue reflecting, red and green transmitting dichroic mirror. Blue light is separated first as, for a maximum brightness display, it can least tolerate optical power losses, and some red and green light is lost at the blue reflecting dichroic mirror. Next the red light is separated as this is less tolerant to loss than the green portion of the spectrum.

After passing through their respective LCoS image planes each color is recombined using dichroic mirrors similar to those used in the initial color separation process. It is noted the two re-combining dichroic mirrors are very angle sensitive as rotations will move the image planes out of registration. In an embodiment, the optical path lengths from the optical source to each LCoS image plane is essentially the same to enable essentially the same illumination fill factor and pattern to be obtained for each image plane. Similarly the three output colored images from the LCoS are all essentially equidistant from the projection lens, thereby enabling all images to be projected in focus.

The three images are typically combined in the image plane of the projection lens enabling existing projection lenses to be used. The images from the LCoS image generation chips are relayed to the projection lens image plane using standard relay lens techniques to maximize light throughput. The optical paths are arranged so that a single set of relay optics relays the image from each LCoS chip to the projector lens image plane. The relay optics is configured so the magnification from the LCoS image chips to the output image plane matches the output image plane format.

The basic optical system of FIG. 9 lies in a plane in some embodiments, which minimizes the number of optical elements, thereby minimizing scattered light and maintaining maximum image contrast. Each beam splitting cube is mounted on the same surface and all optical paths are co-planer. This facilitates fabrication and optical alignment. The co-planar layout also facilitates thermal control of the LCoS image generators as ‘through the support-plate’ airflow in a direction perpendicular to the plane of the optical system is easily configured and keeps the cooling air away from the optical path, reducing the possibility of optical artifacts created by air turbulence.

The LCoS image projector may use existing projection display components such as lamp hoses and associated power supplies, and available projection lenses. Both lamp houses and projection lenses are typically close to the image plane in film projectors. The light output from the lamp house is therefore relayed to the LCoS image chips by illumination relay optics with a magnification that matches the lamp output area to the image chip area.

A further discussion of potential embodiments may be useful. In one embodiment, a system is provided. The system includes an array of a first plurality of narrowband light sources. The system also includes a first beam collecting component arranged to receive light from the first plurality of narrowband light sources and arranged to output light including light from each light source of the first plurality of narrowband light sources. In one embodiment, the light sources are laser diodes. In another embodiment, the light sources are light emitting diodes (LEDs).

Furthermore, in one embodiment using LEDs, the first plurality of light sources includes light sources with 10 unique frequency spectra. Moreover, in one embodiment, the system further includes a substrate upon which the first plurality of light sources is formed, the substrate having heat conductive properties. Additionally, in some embodiments, a cooling component is coupled to the substrate.

Also, in some embodiments, a first plurality of focusing optical components is disposed between each light source of the first plurality of light sources and the first beam collecting component. In some embodiments, the first beam collecting component is a substantially flat diffraction grating. In other embodiments, the first beam collecting component is a curved diffraction grating.

Some embodiments further include an array of a second plurality of narrowband light sources. Such embodiments may also include a second beam collecting component arranged to receive light from the second plurality of narrowband light sources and arranged to output light including light from each light source of the second plurality of narrowband light sources.

Such embodiments may also includes a beam combining component arranged to receive output light from the first beam collecting component and the second beam collecting component. The beam combining component may be a polarization combiner in some embodiments. Moreover, the first plurality of light sources may be arranged to produce light of a first polarization and the second plurality of light sources may be arranged to produce light of a second polarization.

In some embodiments, the system may further include a housing coupled to the first plurality of light sources and to the beam combining element. The system may also further include a first LCoS assembly coupled to the housing. The system may also include a second LCoS assembly coupled to the housing. The system may further include a third LCoS assembly coupled to the housing. The system may also include a first beam splitter and a second beam splitter both coupled to the housing. The first beam splitter may be arranged to split incoming light from the beam combining element between the first LCoS assembly and the second beam splitter. The second beam splitter may be arranged to split incoming light between the second LCoS assembly and the third LCoS assembly. The system may also include a first beam recombiner and a second beam recombiner both coupled to the housing, the first beam recombiner arranged to receive light from the first LCoS assembly and the second LCoS assembly, the second beam recombiner arranged to receive light from the first beam recombiner and from the third LCoS assembly. The system may also include an output optics element coupled to the housing and arranged to receive light from the second beam recombiner and to focus an output light source.

In some embodiments, the system further includes a processor and a memory coupled to the processor. The system also includes a bus coupled to the memory and the processor. The system further includes a communications path between the processor and each of the first and second LCoS chips of the first, second and third LCoS assemblies.

In another embodiment, a system is provided. The system includes an array of a first plurality of narrowband light sources. The light sources are formed from light emitting diodes (LEDs). The system also includes a substrate upon which the first plurality of light sources is formed. The substrate has heat conductive properties. The system further includes a cooling component coupled to the substrate. The system also includes a first beam collecting component arranged to receive light from the first plurality of narrowband light sources and arranged to output light including light from each light source of the first plurality of narrowband light sources.

The system may also involve, in some embodiments, each light source including a plurality of LEDs of similar spectral character. In some embodiments, the plurality of light sources includes 10 distinct light sources, with each light source having a substantially non-overlapping output spectrum relative to other light sources of the plurality of light sources. In other embodiments, the plurality of light sources includes 20 distinct light sources, some light sources having output spectrums overlapping output spectra of one or more other light sources of the plurality of light sources.

In yet another embodiment, a system is provided. The system includes an array of a first plurality of narrowband light sources. The light sources are formed from laser diodes (LDs). The system also includes a substrate upon which the first plurality of light sources is formed. The substrate has heat conductive properties. The system further includes a cooling component coupled to the substrate. The system also includes a first beam collecting component arranged to receive light from the first plurality of narrowband light sources and arranged to output light including light from each light source of the first plurality of narrowband light sources. Moreover, the system may involve each light source of the plurality of light sources including multiples LDs having similar spectral character. Likewise, the system may involve each light source of the plurality of light sources having a substantially non-overlapping output spectrum relative to other light sources of the plurality of light sources.

One skilled in the art will appreciate that although specific examples and embodiments of the system and methods have been described for purposes of illustration, various modifications can be made without deviating from present invention. For example, embodiments of the present invention may be applied to many different types of databases, systems and application programs. Moreover, features of one embodiment may be incorporated into other embodiments, even where those features are not described together in a single embodiment within the present document.

1. A system comprising:
An array of a first plurality of narrowband light sources;
And
A first beam collecting component arranged to receive light from the first plurality of narrowband light sources and arranged to output light including light from each light source of the first plurality of narrowband light sources.

2. The system of claim 1, wherein:
The light sources are laser diodes.

3. The system of claim 1, wherein:
The light sources are light emitting diodes (LEDs).

4. The system of claim 3, wherein:
The first plurality of light sources includes light sources with 10 unique frequency spectra.

5. The system of claim 3, further comprising:
A substrate upon which the first plurality of light sources is formed, the substrate having heat conductive properties.

6. The system of claim 5, further comprising:
A cooling component coupled to the substrate.

7. The system of claim 3, further comprising:
A first plurality of focusing optical components disposed between each light source of the first plurality of light sources and the first beam collecting component.

8. The system of claim 1, wherein:
The first beam collecting component is a substantially flat diffraction grating.

9. The system of claim 1, wherein:
The first beam collecting component is a curved diffraction grating.

10. The system of claim 1, further comprising:
An array of a second plurality of narrowband light sources;
A second beam collecting component arranged to receive light from the second plurality of narrowband light sources and arranged to output light including light from each light source of the second plurality of narrowband light sources;
A beam combining component arranged to receive output light from the first beam collecting component and the second beam collecting component.

11. The system of claim 1, wherein:
The beam combining component is a polarization combiner.

12. The system of claim 1, wherein:
The first plurality of light sources is arranged to produce light of a first polarization and the second plurality of light sources is arranged to produce light of a second polarization.

13. The system of claim 1, further comprising:
A housing coupled to the first plurality of light sources and to the beam combining element;
A first LCoS assembly coupled to the housing;
A second LCoS assembly coupled to the housing;
A third LCoS assembly coupled to the housing;
A first beam splitter and a second beam splitter both coupled to the housing, the first beam splitter arranged to split incoming light from the beam combining element between the first LCoS assembly and the second beam splitter, the second beam splitter arranged to split incoming light between the second LCoS assembly and the third LCoS assembly;
A first beam recombiner and a second beam recombiner both coupled to the housing, the first beam recombiner arranged to receive light from the first LCoS assembly and the second LCoS assembly, the second beam recombiner arranged to receive light from the first beam recombiner and from the third LCoS assembly;
And
An output optics element coupled to the housing and arranged to receive light from the second beam recombiner and to focus an output light source.

14. The system of claim 1, further comprising:
A processor;
A memory coupled to the processor;
A bus coupled to the memory and the processor;
And
A communications path between the processor and each of the first and second LCoS chips of the first, second and third LCoS assemblies.

15. A system comprising:
An array of a first plurality of narrowband light sources, the light sources formed from light emitting diodes (LEDs);
A substrate upon which the first plurality of light sources is formed, the substrate having heat conductive properties;
A cooling component coupled to the substrate;
And
A first beam collecting component arranged to receive light from the first plurality of narrowband light sources and arranged to output light including light from each light source of the first plurality of narrowband light sources.

16. The system of claim 15, wherein:
Each light source includes a plurality of LEDs of similar spectral character.

17. The system of claim 15, wherein:
The plurality of light sources includes 10 distinct light sources, each light source having a substantially non-overlapping output spectrum relative to other light sources of the plurality of light sources.

18. The system of claim 15, wherein:
The plurality of light sources includes 20 distinct light sources, some light sources having output spectrums overlapping output spectra of one or more other light sources of the plurality of light sources.

19. A system comprising:
An array of a first plurality of narrowband light sources, the light sources formed from laser diodes (LDs);
A substrate upon which the first plurality of light sources is formed, the substrate having heat conductive properties;
A cooling component coupled to the substrate;
And
A first beam collecting component arranged to receive light from the first plurality of narrowband light sources and arranged to output light including light from each light source of the first plurality of narrowband light sources.

20. The system of claim 19, further comprising:
Each light source of the plurality of light sources includes multiples LDs having similar spectral character;
And
Each light source of the plurality of light sources having a substantially non-overlapping output spectrum relative to other light sources of the plurality of light sources.
